(19) United States
(12) Patent Application Publication
(10) Pub. No.: US 2009/0289225 A1
(43) Pub. Date: Nov. 26, 2009

(54) REDUCING FLUORESCENT SELF-QUENCHING WITH NANOPARTICLES

(76) Inventors: Naiyong Jing, Woodbury, MN (US); William J. Schultz, North Oaks, MN (US)

Correspondence Address: 3M INNOVATIVE PROPERTIES COMPANY, PO BOX 33427, ST. PAUL, MN, 55133-3427, US

(21) Appl. No.: 12/493,813

(22) Filed: Jun. 29, 2009

Related U.S. Application Data
(62) Division of application No. PCT/US2008/060574, filed on Apr. 17, 2008.
(60) Provisional application No. 60/912,711, filed on Apr. 19, 2007.

(51) Int. Cl. C09K 11/06; C07F 7/02

(52) U.S. Cl. 252/301.16; 549/215

(57) ABSTRACT

A method of reducing fluorescent self-quenching comprising attaching fluorescent molecules to nanoparticles so as to thereby reduce the self-quenching of the fluorescent molecules, the resulting fluorescent nanoparticles, and solutions that comprise such fluorescent nanoparticles.

### CROSS REFERENCE TO RELATED APPLICATION

This application claims the benefit of U.S. Provisional Patent Application No. 60/912,711, filed on Apr. 19, 2007, as well as the corresponding International Patent Application No. PCT/US2008/060574, filed Apr. 17, 2008 and published Jan. 15, 2009 with the International Publication No. WO 2009/009188, which are incorporated herein by reference in their entirety.

### BACKGROUND

The self-quenching of fluorescent dye molecules is known. “Self-quenching” generally refers to the quenching of fluorescent light emission due to fluorescent dye-dye intermolecular interaction between fluorescent dye molecules. Such self-quenching can be desirable in applications where the loss of the fluorescent light emission is the useful effect. Such self-quenching, however, can also be undesirable in applications where a strong fluorescent light emission is necessary.

### SUMMARY

The present invention is directed to reducing the self-quenching of fluorescent dye molecules.

In one aspect of the present invention, a method is provided for reducing fluorescent dye-dye quenching (i.e., self-quenching), and thereby increase the intensities of fluorescence from the fluorescent molecules. This method comprises attaching one or more fluorescent molecules to nanoparticles such that the self-quenching of the fluorescent molecules is eliminated or at least significantly reduced compared to the same amount of fluorescent molecules being together without being attached to the nanoparticles. Such self-quenching is considered significantly reduced, when the amount of fluorescent molecules in solution (e.g., in an aqueous solution) would not be visibly fluorescent if the fluorescent molecules were not attached to nanoparticles while in solution. In particular, the method comprises: providing nanoparticles (e.g., silica nanoparticles), each having a surface, providing fluorescent molecules, and attaching one or more fluorescent molecules to the surface of each of the nanoparticles. The fluorescent molecules being provided can each comprise a fluorescent group and a surface-bonding group. In addition, a plurality of the fluorescent groups can be covalently bonded to the surface of a plurality of the nanoparticles through the surface-bonding groups. Preferably, such covalent bonding is through nonreversible covalent bonds.

The nanoparticles can include dispersible groups bonded to the surface through nonreversible covalent bonds. The dispersible groups assist in dispersion of the nanoparticles in a solvent (e.g., aqueous, alcohol, etc.) environment. The dispersible groups can include carboxylic acid groups, sulfonic acid groups, phosphonic acid groups, salts thereof, or combinations thereof.

The nanoparticles can also include shielding groups bonded to the surface through nonreversible covalent bonds. For certain embodiments, the shielding groups include poly(alkylene oxide)-containing groups, preferably poly(ethylene oxide)-containing groups. For certain embodiments, the shielding groups comprise poly(alkylene oxide)-containing groups, ethylene glycol ether-containing groups, poly(ethylene oxide) ether-containing groups, ethylene glycol lactate-containing groups, sugar-containing groups, polyol-containing groups, crown ether-containing groups, oligo glycidyl-containing groups, hydroxyl acrylamide-containing groups, organosulfonate-containing groups, organocarboxylate-containing groups, or combinations thereof.

The shielding groups and the dispersible groups may be of the same or similar chemical class, and the nanoparticles can include both types of groups.

The method can also include providing a dispersible compound having a dispersible group and a surface-bonding group, and attaching the dispersible compound to the nanoparticles. In addition, the method can include providing a shielding compound having a shielding group and a surface-bonding group, and attaching the shielding compound to the nanoparticles. Furthermore, the method can include providing a combination of such a dispersible compound and a shielding compound, and attaching the dispersible compound and the shielding compound to the nanoparticles.

The fluorescent groups and dispersible groups, and shielding groups can be covalently bonded to the surface of a plurality of the nanoparticles through nonreversible covalent bonds between the surface-bonding groups and the nanoparticle surface. The bound shielding groups can exclude amide groups and/or urea groups.

For certain embodiments, the shielding compound is covalently bonded to the surface of the nanoparticles prior to the fluorescent molecule being bonded thereto.

In another aspect of the present invention, a plurality of fluorescent nanoparticles are provided comprising a plurality of nanoparticles, with each nanoparticle having a surface, and one or more fluorescent molecules bonded to the surface of each nanoparticle in an amount such that self-quenching of the fluorescent molecules is reduced compared to the same amount of fluorescent molecules being together without being attached to the nanoparticles. The fluorescent molecules are preferably bonded to the surface of each nanoparticle such that the fluorescent molecules exhibit no self-quenching.

In an addition aspect of the present invention, a solution is provided that comprises fluorescent nanoparticles according to the present invention. The solution can further comprise water or an alcohol.

### DEFINITIONS

“Nonreversible Covalent bond” or “nonreversibly covalently bonded” in the context of the present invention means a covalent bond that is nonreversible, e.g., under physiologic conditions. This does not include a bond that is in equilibrium under physiologic conditions, such as a gold-sulfur bond, that would allow the attached groups to migrate from one particle to another. Also any foreign species containing —SH or —S—S— are capable of replacing the substitutes on the gold particles via gold-sulfur bond. As a result, the surface composition patterns may be disrupted.

“Nanoparticles” are herein defined as nanometer-sized particles, preferably with an average particle size of no greater than 200 nanometers (nm). As used herein, “particle size” and “particle diameter” have the same meaning and are used to refer to the largest dimension of a particle (or agglomerate thereof).

In this context, “agglomeration” refers to a weak association between particles which may be held together by charge or polarity and can be broken down into smaller entities.

“Dispersible nanoparticles” are nanoparticles having dispersible groups covalently bound thereto in a sufficient amount to provide dispersibility, e.g., in water or alcohol, to the nanoparticles. In this context, “dispersibility” means particles are in the form of individual particles not agglomerates.

“Dispersible groups” are monovalent groups that are capable of providing a hydrophilic surface thereby reducing, and preferably preventing, excessive agglomeration and precipitation of the nanoparticles in a solvent (e.g., aqueous, alcohol, etc.) environment. Certain of the water-dispersible groups may also function as shielding groups (e.g., poly(ethylene oxide)-containing groups).

“Shielding groups” are monovalent groups that are capable of reducing, and preferably preventing, nonspecific binding of molecules other than molecules of interest.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a nanoparticle that comprises “a” fluorescent compound can be interpreted to mean that the nanoparticle includes “one or more” fluorescent compounds.

The term “and/or” means one or all of the listed elements or a combination of any two or more of the listed elements (e.g., preventing and/or treating an affliction means preventing, treating, or both treating and preventing further afflictions).

As used herein, the term “or” is generally employed in its sense including “and/or” unless the content clearly dictates otherwise.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF ILLUSTRATIVE EMBODIMENTS

The invention relates to a new use of functionalized nanoparticles. Silica nanoparticles are particularly desirable for being functionalized and thereby rendered dispersible. The dispersible functionalized nanoparticles of the present invention are useful in the design and fabrication of devices for which dispersible particles are needed for the attachment and immobilization of fluorescent molecules. Additionally, the functionalized nanoparticles of the invention may be used in nanoscale electronic devices, multifunctional catalysts, chemical sensors, and many biological applications such as biosensors, biological assays, and the like.

The nanoparticles of the present invention include fluorescent compounds covalently bonded to the surface, preferably through nonreversible covalent bonds. Dispersibility results from the covalent bonding of dispersible groups to the surface of the nanoparticles. The nanoparticles can also include shielding groups covalently bonded to the nanoparticle surface. Shielding groups can be used to reduce, and preferably prevent, the nonspecific binding of molecules other than the molecules of interest. Such dispersible and shielding groups are covalently bonded to the nanoparticle surface, preferably through nonreversible covalent bonds.

With silica nanoparticles, it is generally advisable to have high coverage of the reactive silanols on the surface of the silica nanoparticles to reduce the tendency for agglomeration and nonspecific binding. It is usually advisable that most of the silanol bonding or reacting sites are reacted with dispersible and/or shielding groups. As suitable nanoparticles of this invention typically have very large number of accessible silanol bonding sites (e.g., 5 nm particles can have 270 accessible silanol groups, 20 nm particles can have 3200 accessible silanol groups, 90 nm particles can have 50,000 accessible silanol groups), even a high percentage coverage by shielding and/or dispersible groups does not preclude the attachment of a useful number of fluorescent compounds.

The reactive groups on the nanoparticles are complementary groups capable of reacting with the surface-bonding group A (see below) in the compounds which bind to the surface (fluorescent compounds of the formula A-F or A-L-F, shielding compounds of the formula A-Sh or A-L-Sh, and dispersible (e.g., water-dispersible) compounds of the formula A-D or A-L-D, as discussed below). Any suitable combination of surface reactive groups (i.e., the reactive groups on the nanoparticle surface) and surface-bonding groups A may be used.

In the above formulations, L represents an organic linker or a bond. Organic linkers L can be linear or branched alkylene, arylene, or a combination of alkylene and arylene groups, optionally including heteroatoms (including S, O, N, P, or mixtures thereof). Examples of L groups include ethylene oxide-containing oligomers or polymeric groups, ethyleneimine-containing oligomers or polymeric groups, and ethylenesulfide-containing oligmers or polymeric groups. Although the L groups can include divalent ethylene oxide-containing oligomers or polymeric groups, for example, which may also provide shielding and/or hydrophilic characteristics to the nanoparticles, the shielding groups and hydrophilic groups referred to herein are separate and distinct monovalent groups. By this it is meant that the shielding groups and hydrophilic groups are terminal groups and not a divalent linker for another group.

### Fluorescent Groups

Examples of fluorescent groups include coumarin, fluorescein, fluorescein derivatives, rhodamine, and rhodamine derivatives. Combinations of different fluorescent molecules can be used if desired. It may be possible to use a combination of different particles with the same or different fluorescent molecules. For example, one type of nanoparticle in a mixture could be tagged with fluorescein and another type of particle could be tagged with rhodamine.

The fluorescent molecules can be covalently bonded directly to the surface of the nanoparticles, or it is possible to attach fluorescent molecules to the surface of the nanoparticles through another molecule (e.g., avidin) noncovalently. It is also possible to attach a fluorescent molecule (e.g., carboxyfluorescein and aminofluorescein) through ionic or hydrophobic interactions.

Preferably, the fluorescent group is fluorescein such as that derived from a triethoxysilyl substituted fluorescein dye.

The fluorescent compounds or groups are typically attached directly to the surface of the nanoparticles (preferably through covalent bonds, and more preferably through nonreversible covalent bonds). Fluorescent molecules or groups can also be attached to the surface of a nanoparticle using a compound (A-F) or (A-L-F), wherein F is the fluorescent group, A is a surface-bonding group, and L can be a bond or any of a variety of organic linker. Organic linkers L can be linear or branched alkylene, arylene, or a combination of alkylene and arylene groups, optionally including heteroatoms. For certain embodiments, the L groups do not include divalent alkylene oxide-containing oligomeric or polymeric groups. For certain embodiments, if the L groups do include divalent alkylene oxide-containing oligomeric or polymeric groups that could provide shielding and/or dispersible characteristics to the nanoparticles, they are not the only shielding and/or dispersible groups present on the nanoparticles.

Suitable surface-bonding groups A of the fluorescent compounds (A-F) or (A-L-F) are described herein in the section entitled Nanoparticles. Examples include silanols, alkoxysilanes, or chlorosilanes.

An example of a fluorescent compound is triethoxysilyl-substituted fluorescein. Those of ordinary skill in the art will recognize that a wide variety of other fluorescent compounds are useful in the present invention. Exemplary conditions for reacting such fluorescent compounds with silica nanoparticles are described herein. Preferably, a sufficient amount of fluorescent compound is reacted with the nanoparticles to provide the desired level of detectability such as, for example, when used in labeling.

Fluorescent groups attached to nanoparticles are particularly beneficial if the fluorescent groups are hydrophobic. For example, relatively hydrophobic fluorescent dye molecules can be well dispersed in an aqueous media when attached to nanoparticles, especially when attached to nanoparticles partially covered by water-dispersing groups. Nanoparticles can reduce fluorescent dye-dye interactions, therefore reducing the quenching (i.e., self-quenching) and increasing the intensities of fluorescence. Nanoparticles also enable attaching many dye molecules, which improves signal intensity compared with conventional approaches of attaching dyes onto antibodies or other biomolecules.

Therefore, fluorescent molecules can be used as signaling groups that provide a detectable signal.

### Nanoparticles

Nanoparticles that are surface modified in accordance with the present invention can comprise nanometer-sized silica. The term “nanometer-sized” preferably refers to particles that are characterized by an average particle size (or average particle diameter for spherical particles) of no greater than 200 nm (prior to surface modification). More preferably, the average particle size is no greater than 150 nanometers (prior to surface modification), even more preferably no greater than 120 nm (prior to surface modification), and even more preferably no greater than 100 nm (prior to surface modification). Suitable nanoparticles of this invention can also be up to 90 nm (prior to surface modification) or even up to 20 nm (prior to surface modification). Preferably, prior to surface modification, the average particle size of the silica nanoparticles is at least 5 nm, and more preferably at least 10 nm.

Average particle size of the nanoparticles can be measured using transmission electron microscopy. In the practice of the present invention, particle size may be determined using any suitable technique. Preferably, particle size refers to the number average particle size and is measured using an instrument that uses transmission electron microscopy or scanning electron microscopy. Another method to measure particle size is dynamic light scattering that measures weight average particle size. One example of such an instrument found to be suitable is the N4 PLUS SUB-MICRON PARTICLE ANALYZER available from Beckman Coulter Inc. of Fullerton, Calif.

It is also preferable that the nanoparticles be relatively uniform in size. Uniformly sized nanoparticles generally provide more reproducible results. Preferably, variability in the size of the nanoparticles is less than 25% of the mean particle size.

Herein, silica nanoparticles are water-dispersible to reduce, and preferably prevent, excessive agglomeration and precipitation of the particles in an aqueous environment. Nanoparticle aggregation can result in undesirable precipitation, gelation, or a dramatic increase in viscosity; however, small amounts of agglomeration can be tolerated when the nanoparticles are in an aqueous environment as long as the average size of the agglomerates (i.e., agglomerated particles) is no greater than 200 nm. Thus, the nanoparticles are preferably referred to herein as colloidal nanoparticles since they can be individual particles or small agglomerates thereof.

The nanoparticles preferably have a surface area of at least 10 m²/gram, more preferably at least 20 m²/gram, and even more preferably at least 25 m²/gram. The nanoparticles preferably have a surface area of greater than 600 m²/gram.

Nanoparticles of the present invention may be porous or nonporous. They can include essentially only silica, or they can be composite nanoparticles such as core-shell nanoparticles. A core-shell nanoparticle can include a core of an oxide (e.g., iron oxide) or metal (e.g., gold or silver) of one type and a shell of silica deposited on the core. Silica is the most preferred nanoparticle, particularly silica nanoparticles derived from a silicate, such as an alkali metal silicate or ammonium silicate.

The unmodified nanoparticles may be provided as a sol rather than as a powder. Preferred sols generally contain from 15 wt-% to 50 wt-% of colloidal silica particles dispersed in a fluid medium. Representative examples of suitable fluid media for the colloidal particles include water, aqueous alcohol solutions, lower aliphatic alcohols, ethylene glycol, N,N-dimethylacetamide, formamide, or combinations thereof. The preferred fluid medium is aqueous, e.g., water and optionally one or more alcohols. When the colloidal particles are dispersed in an aqueous fluid, the particles may be stabilized due to common electrical charges that develop on the surface of each particle. The common electrical charges tend to promote dispersion rather than agglomeration or aggregation, because the similarly charged particles repel one another.

Inorganic silica sols in aqueous media are well known in the art and available commercially. Silica sols in water or water-alcohol solutions are available commercially under such trade names as LUDOX (manufactured by E.I. DuPont de Nemours and Co., Inc., Wilmington, Del.), NYACOL (available from Nyacol Co., Ashland, Mass.) or NALCO (manufactured by Nalco Chemical Co., Oak Brook, Ill.). One useful silica sol is NALCO 2327 available as a silica sol with mean particle size of 20 nanometers, pH 9.5, and solid content 40 wt-%. Additional examples of suitable colloidal silicas are described in U.S. Pat. No. 5,126,394.

The sols used in the present invention generally may include counter cations, in order to counter the surface charge of the colloids. Depending upon pH and the kind of colloids being used, the surface charges on the colloids can be negative or positive. Thus, either cations or anions are used as counter ions. Examples of cations suitable for use as counter ions for negatively charged colloids include Na⁺, K⁺, Li⁺, a quaternary ammonium cation such as NR₄⁺, wherein each R may be any monovalent moiety, but is preferably H or lower alkyl, such as —CH₃, combinations of these, and the like.

A variety of methods are available for modifying the surface of nanoparticles including, e.g., adding a surface modifying agent to nanoparticles (e.g., in the form of a powder or a colloidal dispersion) and allowing the surface modifying agent to react with the nanoparticles. Other useful surface modification processes are described in, e.g., U.S. Pat. No. 2,801,185 (Iler), U.S. Pat. No. 5,648,407 (Goetz et al.) and U.S. Pat. No. 4,522,958 (Das et al.). Alkoxysilanes, silanols, and chlorosilanes are particularly useful in modifying a surface containing silica. These alkoxysilanes, silanols, and chlorosilanes can be monofunctional, difunctional, or trifunctional.

### Dispersible Groups

Dispersible groups like water-dispersible groups are monovalent groups that are capable of providing hydrophilic characteristics to the nanoparticle surface, thereby reducing, and preferably preventing, excessive agglomeration and precipitation of the nanoparticles in an aqueous buffer solutions (although small amounts of agglomeration can be tolerated when the nanoparticles are in an aqueous environment as long as the average size of the agglomerates is preferably no greater than 200 nm). By monovalent, it is meant that the dispersible groups do not have an end group that could react with, or immobilize, the fluorescent molecule of interest. Thus, the dispersible groups are separate and distinct from the fluorescent compounds.

Preferably, the water-dispersible nanoparticles are storage-stable in an aqueous buffer solution. By this, it is meant that an aqueous dispersion of the water-dispersible nanoparticles is not subject to de-emulsification and/or coagulation or agglomeration at temperatures greater than 20° C., over a period of at least one year, when in a buffer.

As used herein, the term “water-dispersible compound” describes a compound that can react with a surface of the nanoparticles to modify it with water-dispersible groups. It can be represented by the formula A-WD or A-L-WD, wherein A are the surface-bonding groups, which may be the same or different as other surface-bonding groups described herein, WD represents the water-dispersible groups, and L represents an organic linker or a bond. Organic linkers L can be linear or branched alkylene, arylene, or a combination of alkylene and arylene groups, optionally including heteroatoms.

The water-dispersible groups are hydrophilic or water-like groups. They typically include, for example, nonionic groups, anionic groups, cationic groups, groups that are capable of forming an anionic group or cationic group when dispersed in water (e.g., salts or acids), or mixtures thereof.

Examples of nonionic water-dispersible groups include poly(alkylene oxide) groups and polyhydroxy-containing groups (including sugar-containing groups). A preferred nonionic water-dispersible group is a poly(alkylene oxide) group (preferably a macromonomer) that is monovalent, and has at least one —CH₂—CH₂—O— (repeat) unit, and may have —CH(R¹)—CH₂—O— repeat units, such that the macromonomer has a total of at least one, and preferably at least five, —CH₂—CH₂—O— (repeat) units, and the ratio of —CH₂—CH₂—O— repeat units to —CH(R¹)—CH₂—O— repeat units is at least 2:1. Thus, a small amount of propylene oxide can be included in the poly(alkylene oxide) groups, although it is not desired.

The anionic or anion-forming groups can be any suitable groups that contribute to anionic ionization of the surface. For example, suitable groups include carboxylate groups (—CO₂— groups, including polycarboxylate), sulfate groups (—SO₄⁻ groups, including polysulfate), sulfonate groups (—SO₃⁻ groups, including polysulfonate), phosphate groups (—PO₄⁻ groups, including polyphosphate), phosphonate (—PO₃⁻ groups, including polyphosphonate), and similar groups, and acids thereof.

The cationic or cation-forming groups can be any suitable groups that contribute to cationic ionization of the surface. For example, suitable groups include quaternary ammonium, phosphonium, and sulfonium salts.

In certain embodiments, preferred water-dispersible groups include carboxylic acid groups, sulfonic acid groups, phosphonic acid groups, or combinations thereof.

The attachment of water-dispersible groups on the surface of silica nanoparticles, significantly, means that dispersions thereof do not require external emulsifiers, such as surfactants, for stability. However, if desired anionic and cationic water-dispersible compounds can also be used in a composition that includes the functionalized nanoparticles to function as an external emulsifier and assist in the dispersion of the nanoparticles.

The water-dispersible groups can be provided using water-dispersible compounds of the formula A-WD or A-L-WD. Suitable surface-bonding groups A of the water-dispersible compounds are described herein in the section entitled Nanoparticles. Examples include silanols, alkoxysilanes, or chlorosilanes.

Some preferred water-dispersible compounds include the following:

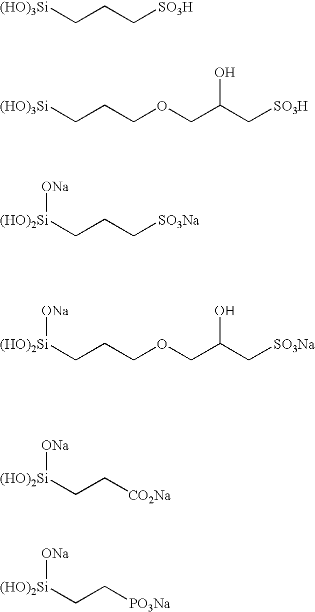

as well as other known compounds.

Those of ordinary skill in the art will recognize that a wide variety of other water-dispersible compounds are useful in the present invention as external emulsifiers or as compounds that can be used to modify the silica nanoparticles with water-dispersible groups. Exemplary conditions for reacting such compounds with silica nanoparticles are described in the Examples Section.

Preferably, a sufficient amount of water-dispersible compound is reacted with the silica nanoparticles to provide the desired level of water-dispersibility without interfering with attachment of the fluorescent compounds. Preferably, the desired level of water-dispersibility is such that an external emulsifier is not necessary for preparing a storage-stable dispersion.

### Shielding Groups

“Shielding groups” are monovalent groups that are capable of reducing, and preferably preventing, nonspecific binding of molecules other than the molecules of interest (e.g., fluorescent molecules). By monovalent, it is meant that the shielding groups do not have an end group that could react with, or immobilize, the molecule of interest. Certain of the hydrophilic groups described below may also function as shielding groups (e.g., poly(ethylene oxide)-containing groups, polyhydroxy-containing groups, sulfonic acid groups). The shielding groups are separate and distinct from the fluorescent compounds. That is, in certain embodiments, the nanoparticles include monovalent groups that provide shielding characteristics even though the same moiety may form a linker for the fluorescent compounds to the surface of the nanoparticles.

As used herein, the term “shielding compound” describes a compound that can react with the surface of the nanoparticles to modify it with shielding groups. It can be represented by the formula A-Sh or A-L-Sh, wherein A are the surface-bonding groups, which may be the same or different as other surface-bonding groups described herein, Sh represents the shielding groups, and L represents an organic linker or a bond. Organic linkers L can be linear or branched alkylene, arylene, or a combination of alkylene and arylene groups, optionally including heteroatoms.

The shielding group serves to block the binding of certain undesirable materials to the surface of the nanoparticles and permits the nanoparticles to be used to bind, isolate, or immobilize specific molecules. The principal requirement of the shielding group is that it not bind a molecule of interest.

The shielding groups typically include, for example, nonionic groups (such as poly(alkylene oxide)-containing groups, preferably poly(ethylene oxide)-containing groups, ethylene glycol ether-containing groups, poly(ethylene oxide) ether-containing groups, ethylene glycol lactate-containing groups, sugar-containing groups, polyol-containing groups, crown ether-containing groups, oligo glycidyl ether-containing groups including methyl ether and hydroxyethyl ether, hydroxyl acylamide-containing groups), anionic groups (e.g., sulfonate and carboxylate groups as described above as water-dispersible groups), and groups that are capable of forming an anionic group when dispersed in water (e.g., salts or acids). Various mixtures or combinations of such groups can be used if desired.

Preferably, a shielding group is an uncharged, water-soluble polymeric molecule of well defined length. Polymers of excessive length may have the effect of blocking the binding sites on the fluorescent compounds and thus their polymer length is preferably controlled.

Preferred shielding groups include, but are not limited to, poly(alkylene oxide)-containing groups (preferably short-chain oligomers having a molecular weight as low as 88, with a random or block structural distribution if at least two different moieties are included), ethylene glycol ether-containing groups, poly(ethylene oxide) ether-containing groups, ethylene glycol lactate-containing groups, sugar-containing groups, polyol-containing groups, crown ether-containing groups, oligo glycidyl ether-containing groups including methyl ether and hydroxyethyl ether, hydroxyl acylamide-containing groups (including oligomers and polymers of acrylamide), organosulfonate-containing groups, organocarboxylate-containing groups, or combinations thereof.

A preferred shielding group is a poly(ethylene oxide)-containing group (preferably a macromonomer) that is monovalent, and has at least one —CH₂—CH₂—O— (repeat) unit, and may have —CH(R¹)—CH₂—O— (repeat) units, such that the macromonomer has a total of at least one, and preferably at least five, —CH₂—CH₂—O— (repeat) units, and the ratio of —CH₂—CH₂—O— units to —CH(R¹)—CH₂—O— units is at least 2:1 (preferably at least 3:1). If the poly(ethylene oxide)-containing groups also include —CH(R¹)—CH₂—O— groups, R¹ is a (C₁-C₄) alkyl group, which can be linear or branched. Thus, a small amount of propylene oxide (e.g., 0.2 mmol/gram of a nanoparticle) can be included in the poly(alkylene oxide) groups, although it is not desired.

Preferably, the molecular weight of the poly(ethylene oxide)-containing groups is at least 100 g/mole, more preferably at least 500 g/mole. It is generally preferred that they are limited in chain length such that they are less than the entanglement molecular weight of the oligomer. The term “entanglement molecular weight” as used in reference to the shielding group attached to the surface means the minimum molecular weight beyond which the polymer molecules used as the shielding group show entanglement. Methods of determining the entanglement molecular weight of a polymer are known, see for example Friedrich et al., Progress and Trends in Rheology V, Proceedings of the European Rheology Conference, 5th, Portoroz, Slovenia, Sep. 6-11, 1998 (1998), 387. Editor(s): Emri, I. Publisher: Steinkopff, Darmstadt, Germany. Preferably, the molecular weight of such polymeric groups is no greater than 10,000 grams per mole (g/mole).

While not meaning to suggest a mechanism for this preference, it is believed that short chain shielding groups are more suitable as opposed to long polymer chains to avoid blocking the binding sites of the fluorescent group. Longer chain shielding groups may block the fluorescent compounds, preventing any binding from occurring.

The surface density and identity of the shielding groups on a surface will depend on the desired efficiency of the overall system and method, taking into account a variety of factors such as cost of starting materials, the surface density and identity of the fluorescent compounds, the surface density and identity of the water-dispersible groups (if included), ease of synthesis, and the sensitivity (e.g., signal to noise ratio) of the desired detection system. For example, the ratio of poly(ethylene oxide)-containing groups to amine-containing fluorescent compounds is at least 0.15:1 to prevent gelation (for nanoparticles); however for low nonspecific binding, the ratio of poly(ethylene oxide)-containing groups to amine-containing fluorescent compounds is at least 2:1.

Suitable surface-bonding groups A of the shielding compounds are described herein in the section entitled Nanoparticles. Examples include silanols, alkoxysilanes, or chlorosilanes.

Examples of shielding compounds include poly(ethylene oxide) trimethoxysilane, (OH)₃Si(CH₂)₃OCH₂CH(OH)CH₂SO₃H, and carboxylethyl silanetriol sodium salt. Those of ordinary skill in the art will recognize that a wide variety of other shielding compounds are useful in the present invention as compounds that can be used to modify the nanoparticles with shielding groups. Exemplary conditions for reacting such compounds with silica nanoparticles are described in the Examples Section. Preferably, a sufficient amount of shielding compound is reacted with the nanoparticles to provide the desired level of nonspecific binding without interfering with attachment of the fluorescent fluorescent compounds.

### Methods of Making and Methods of Use

The nanoparticles of the present invention can be made in a variety of ways. Typically, compounds containing surface-bonding groups (e.g., silica-binding groups) and the desired fluorescent groups, water-dispersible groups, and/or shielding groups can be contacted with the nanoparticles under conditions effective to attach (preferably covalently bond, and more preferably nonreversibly covalently bond as defined herein) the groups to the silica surface of the nanoparticles. An exemplary set of conditions is specified below. The order of addition can involve attaching the shielding groups first. Although it is believed that the order of addition is not critical.

Objects and advantages of this invention are further illustrated by the following example, but the particular materials and amounts thereof recited in this example, as well as other conditions and details, should not be construed to unduly limit this invention.

All parts, percentages, ratios, etc. in the examples are by weight, unless noted otherwise. All aqueous solutions were made using MILLI-Q™ purified water (Millipore, Billerica, Mass.), unless otherwise noted.

### EXAMPLE

### Preparation of Silica Nanoparticles Modified with Fluorescent Groups and Poly(Ethylene Oxide) Shielding Groups

A sample of 365 grams of NALCO 2327 silica (150 g, a 20-nanometer (20-nm) ammonia-stabilized silica particle, available from Nalco Co., Naperville, Ill.) at 40.88% solids in water was added to a reaction vessel. A sample of 30 grams of SILQUEST A-1230, a 500 molecular weight trimethoxysilane functional poly(ethylene oxide) (PEG-silane) from GE Silicones, was added to the reaction vessel. The solution was heated for 16 hours at 80° C. The reaction product was a clear fluid dispersion and included 0.4 millimolar (mmol) silane-substituted poly(ethylene oxide) oligomers per gram of 20-nm diameter silica nanoparticles.

A sample of 19.5 milligrams (mg) of fluorescein isothiocyanate (technical grade from Alfa Aesar, Ward Hill, Mass.) was added to a small vial. The dye was completely dissolved in 0.23 gram (g) of dry methyl sulfoxide (DMSO). A sample of 0.12 g of a 10% solution of 3-aminopropyltriethoxysilane in DMSO was added to the dye solution and reacted for 60 minutes at 60° C. to form a silane-functional fluorescein dye.

To an aqueous solution containing dispersed PEG-modified silica nanoparticles described above (58.5 g and 25 g of silica) was added the freshly prepared silane-functional fluorescein dye in DMSO. The mixture was subsequently heated for 16 hours at 60° C. to form fluorescein- and PEG-functional silica nanoparticles.

The following are calculations determining the theoretical number of fluorescein molecules attached to bonding sites on each 20 nm particle in the exemplary amounts of nanoparticles.

### Equation:

# of fluorescent molecules/particle=(mgs of fluorescent dye used)/[(gms of nanoparticles)(# of sites/nanoparticle in mmol/g) (molecular weight of dye molecule)]

### Assumptions:

With approx. 3000 sites per 20 nm particle, 0.62 mmol/g equals 100% coverage. Therefore, the number of sites per silica particle is: 0.62/3000=2.07×10⁻⁴

### Calculation 1 (58.5 g Silica):

fluorescent molecules/particle=19.5 mg fluorescein/[(58.5 g silica)(2.07×10⁻⁴)(389.38 g/mol dye)=4.13 or approx. 4 fluorescein molecules/nanoparticle

### Calculation 2 (25 g Silica):

fluorescent molecules/particle=19.5 mg fluorescein/[(25 g silica)(2.07×10⁻⁴)(389.38 g/mol dye)=9.68 or approx. 10 fluorescein molecules/nanoparticle

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A method for reducing fluorescent self-quenching, said method comprising:
providing a plurality of nanoparticles, with each nanoparticle having a surface;
providing a plurality of fluorescent molecules; and
attaching one or more fluorescent molecules to the surface of each nanoparticle such that self-quenching of the fluorescent molecules is reduced compared to the same amount of fluorescent molecules being together without being attached to the nanoparticles.

2. The method of claim 1, wherein the fluorescent molecules are bonded to the surface of each nanoparticle such that the fluorescent molecules exhibit no self-quenching.

3. The method according to claim 1, wherein the surface of each nanoparticle comprises at least about 270 bonding sites.

4. The method according to claim 3, wherein there is a theoretical average of less than 10 of the fluorescent molecules bonded to the surface of each nanoparticle.

5. The method according to claim 3, wherein each of the fluorescent molecules being provided comprises a fluorescent group and a surface-bonding group, with each surface-bonding group being bondable to one nanoparticle bonding site.

6. The method according to claim 4, wherein each of the fluorescent molecules are attached to one nanoparticle bonding site using a compound (A-L-F), where F is the fluorescent molecule, A is a surface-bonding group, and L is a bond or an organic linker.

7. The method according to claim 1, wherein said providing the nanoparticles includes dispersing the nanoparticles in solution; and said attaching one or more fluorescent molecules includes dispersing the fluorescent molecules in the solution of nanoparticles.

8. The method according to claim 4, wherein each of the nanoparticles is partially covered by dispersing groups, shielding groups, or a combination thereof bonded to bonding sites on the surface of each nanoparticle.

9. The method according to claim 8, wherein each of the nanoparticles is partially covered by water-dispersing groups selected from carboxylic acid groups, sulfonic acid groups, phosphonic acid groups, salts thereof, or combinations thereof.

10. The method according to claim 8, wherein the shielding groups are selected from poly(alkylene oxide)-containing groups, poly(ethylene oxide)-containing groups, ethylene glycol ether-containing groups, poly(ethylene oxide) ether-containing groups, ethylene glycol lactate-containing groups, sugar-containing groups, polyol-containing groups, crown ether-containing groups, oligo glycidyl-containing groups, hydroxyl acrylamide-containing groups, organosulfonate-containing groups, organocarboxylate-containing groups, or combinations thereof.

11. A plurality of fluorescent nanoparticles comprising:
a plurality of nanoparticles, with each nanoparticle having a surface, and one or more fluorescent molecules bonded to the surface of each nanoparticle in an amount such that self-quenching of said fluorescent molecules is reduced compared to the same amount of fluorescent molecules being together without being attached to said nanoparticles.

12. The fluorescent nanoparticles according to claim 11, wherein said fluorescent molecules are bonded to the surface of each nanoparticle such that said fluorescent molecules exhibit no self-quenching.

13. The fluorescent nanoparticles according to claim 11, wherein the surface of each nanoparticle comprises at least about 270 bonding sites.

14. The fluorescent nanoparticles according to claim 12, wherein there is a theoretical average of less than 10 of said fluorescent molecules bonded to the surface of each nanoparticle.

15. The fluorescent nanoparticles according to claim 14, wherein said nanoparticles have an average particle size of less than 90 nm.

16. The fluorescent nanoparticles according to claim 11, wherein the surface of each nanoparticle comprises at least about 270 bonding sites, there is a theoretical average of less than 10 of said fluorescent molecules bonded to the surface of each nanoparticle, and said nanoparticles have an average particle size of less than 90 nm.

17. The fluorescent nanoparticles according to claim 11, wherein the surface of each nanoparticle comprises bonding sites, each of said fluorescent molecules is bonded to a surface-bonding group, and each said surface-bonding group is attached to at least one bonding site.

18. The fluorescent nanoparticles according to claim 3, wherein the surface of each nanoparticle comprises bonding sites, and each of said fluorescent molecules is attached to one bonding site using a compound (A-L-F), where F is said fluorescent molecule, A is a surface-bonding group, and L is a bond or an organic linker.

19. A solution comprising fluorescent nanoparticles according to claim 1.

20. The solution according to claim 19, further comprising water or an alcohol.
